(19) United States
(12) Patent Application Publication
(10) Pub. No.: US 2012/0245830 A1
(43) Pub. Date: Sep. 27, 2012

(54) METHOD FOR MONITORING A COOLANT TEMPERATURE SENSOR AND/OR A CYLINDER HEAD TEMPERATURE SENSOR OF A MOTOR VEHICLE AND CONTROL DEVICE

(76) Inventors: Gerhard Eser, Hemau (DE); Stefan Seyfferth, Regensburg (DE)

(21) Appl. No.: 13/382,180

(22) PCT Filed: Dec. 9, 2010
(86) PCT No.: PCT/EP2010/069230

§ 371 Date: Feb. 22, 2012

(30) Foreign Application Priority Data
Dec. 16, 2009 (DE) 10 2009 058 514.1

(51) Int. Cl. F01P 11/00; F02D 28/00; G06F 11/30

(52) U.S. Cl. 701/113; 701/30.3

(57) ABSTRACT

In a method for monitoring a coolant temperature sensor and/or a cylinder head temperature sensor of a motor vehicle, during a start (t=tSt) of an internal combustion engine of the motor vehicle an actual value (TCOist=TCOSt) of a coolant temperature (TCO) is determined by a coolant temperature sensor, and an actual value (TCYLHist=TCYLHSt) of the cylinder head temperature (TCYLH) is determined by a cylinder head temperature sensor, wherein the coolant temperature sensor and/or the cylinder head temperature sensor are diagnosed as functional sensors when the actual values (TCOist, TCYLHist) of the coolant temperature (TCO) and the cylinder heat temperature (TCYLH) deviate in the same direction upward in relation to an outside temperature (TAM) and/or an intake air temperature (TIA). By a control device, particularly a motor control device, a method can be and is carried out accordingly.

### CROSS-REFERENCE TO RELATED APPLICATIONS

This application is a U.S. National Stage Application of International Application No. PCT/EP2010/069230 filed Dec. 9, 2010, which designates the United States of America, and claims priority to German Application No. 10 2009 058 514.1 filed Dec. 16, 2009, the contents of which are hereby incorporated by reference in their entirety.

### TECHNICAL FIELD

The invention relates to a method for monitoring a coolant temperature sensor and/or a cylinder head temperature sensor of a motor vehicle. The invention also relates to a control device, in particular an engine control device, by means of which a method according to the invention can be carried out or is carried out.

### BACKGROUND

It is very important to know a coolant temperature of an engine cooling system during operation of an internal combustion engine of a motor vehicle. For this reason, particular importance is attached to monitoring one or more coolant temperature sensors by law. A faulty or non-functional coolant temperature sensor means that the internal combustion engine can no longer be controlled in an optimum manner, this possibly leading to increased emissions and to damage to the point of breakdown of the internal combustion engine.

Therefore, it is necessary, for example, to monitor, that is to say detect, a “hanging” coolant temperature sensor, this process being carried out in cooling systems with mechanical thermostats when the vehicle is stationary. In this case, a “hanging” coolant temperature sensor is to be understood to mean a temperature sensor of which the measured value does not change or changes only slightly over a relatively long period of time or exhibits only low dynamics at its output measured value. Monitoring of this kind can be influenced by an additional heating system, which is installed in the motor vehicle, when the internal combustion engine is started. Furthermore, attempts are increasingly being made to diagnose hanging coolant temperature sensors even during operation of the internal combustion engine.

DE 196 08 340 A1 discloses a method for controlling an internal combustion engine which, before the internal combustion engine is started, checks whether the internal combustion engine has been preheated by means of a block heater. A difference between a temperature of the internal combustion engine and a temperature of the intake air of the internal combustion engine serves as a measure of this. If this difference is greater than a predetermined minimum value, it is assumed that the internal combustion engine has been preheated by means of the block heater and this is taken into consideration for controlling the internal combustion engine when it is actually started.

The operation of an additional heating system is generally provided as an item of information to an engine control device of the motor vehicle. This information can be used to influence monitoring of the coolant temperature sensor so as to correct it or to suppress said monitoring for a specific period of time, for example an entire driving cycle. However, this information is not always correct when the internal combustion engine is started. In addition, the detection of a hanging coolant temperature sensor in internal combustion engines with switchable coolant pumps is made more difficult since in this case there is no change or only a slight change in the coolant temperature after the internal combustion engine is started. This is due to the coolant pump being switched on only with a time delay after the internal combustion engine is started in order to thus achieve a rapid increase in a temperature in a cylinder head of the internal combustion engine.

Furthermore, additional heating systems which have been retrofitted in a vehicle are problematical since the influence of said additional heating systems cannot be taken into consideration by the manufacturer in advance. Undesired or inconsistent incorrect entries into a control device during monitoring of the coolant temperature sensor may result, in particular, in the case of an “after-market product” of this kind, for example a motor vehicle which is equipped with a stationary heating system or a block heater. This may lead to replacement of a coolant temperature sensor even though it is fully functional, this therefore creating unnecessary costs.

### SUMMARY

According to various embodiments, in a method for monitoring a coolant temperature sensor and/or a cylinder head temperature sensor of a motor vehicle, when an internal combustion engine of the motor vehicle is started, an actual value of a coolant temperature is determined by a coolant temperature sensor, and an actual value of a cylinder head temperature is determined by a cylinder head temperature sensor, wherein the coolant temperature sensor and/or the cylinder head temperature sensor are/is diagnosed as a functional sensor when the actual values of the coolant temperature and of the cylinder head temperature deviate in the same direction upward in relation to an outside temperature and/or an intake air temperature.

According to a further embodiment, for the purpose of starting the internal combustion engine, a decision can initially be made as to whether the coolant temperature and/or the cylinder head temperature have/has an unexpectedly high actual value, and the deviation in the same direction of the actual values of the coolant temperature and of the cylinder head temperature upward can be preferably examined only in such a case. According to a further embodiment, for the purpose of starting the internal combustion engine, the actual value of the coolant temperature and/or the actual value of the cylinder head temperature can be compared with the outside temperature and/or the intake air temperature, and in the case of a specific deviation in one or both temperatures, an unexpectedly high actual value for the coolant temperature and/or an unexpectedly high actual value for the cylinder head temperature can be output, and the method can be carried out after this. According to a further embodiment, a functional coolant temperature sensor and/or a functional cylinder head temperature sensor can be diagnosed, or the internal combustion engine can be started with previous additional heating of the motor vehicle, by: a predetermined deviation of the coolant temperature and/or the cylinder head temperature from the external temperature and/or the intake air temperature; a predetermined deviation in the coolant temperature from the cylinder head temperature if the two temperatures deviate upward from the outside temperature and/or the intake air temperature; a predetermined positive gradient of the coolant temperature and/or the cylinder head temperature after the internal combustion engine is started; and examination of a dynamic behavior of the cylinder head temperature in relation to the coolant temperature after the internal combustion engine is started, wherein a comparative value which is ascertained for this purpose in each case is preferably a current, average, minimum and/or maximum value. According to a further embodiment, a defective coolant temperature sensor or a defective cylinder head temperature sensor can be diagnosed when either the actual value of the coolant temperature or the actual value of the cylinder head temperature does not increase after the internal combustion engine is started. According to a further embodiment, the profile of the coolant temperature and/or the cylinder head temperature can be monitored after the internal combustion engine is started, wherein the profile can be preferably monitored with a narrow time frame and is continued until a specific respective temperature is reached and/or lasts for a specific respective time period. According to a further embodiment, a duration of a time window for an initial increase in the actual value of the coolant temperature and/or the actual value of the cylinder head temperature can be 1 s, preferably 0.75 s, particularly 0.4 s, particularly preferably 0.2 s and very particularly preferably 0.1 s, after the internal combustion engine is started. According to a further embodiment, the method can be carried out only after a comparatively long downtime of the internal combustion engine, and the downtime is at least 8 h, preferably at least 7 h, particularly at least 6 h, particularly preferably at least 5 h and very particularly preferably at least 4 h, and/or the method is carried out only in the case of a low outside temperature which is ascertained by an ambient temperature sensor, an intake air temperature sensor or in some other way, and the outside temperature ascertained in the process is below 10° C., preferably below 5° C., particularly below 0° C., particularly preferably below −5° C. and very particularly preferably below −10° C. According to a further embodiment, the additional heating system can be a heating system which is independent of the internal combustion engine and comprises an internal or an external additional electrical or combustion heating system, wherein the additional heating system is, in particular, a preheating system, a stationary heating system, a block heater, an auxiliary fuel heater, an additional air or coolant heating system, an additional PTC heating system, a glow plug and/or another heating device.

According to another embodiment, a control device, in particular an engine control device for a motor vehicle, may carry out a method as described above.

### BRIEF DESCRIPTION OF THE DRAWINGS

The invention will be explained in greater detail below using exemplary embodiments with reference to the appended drawing. In the schematic graphs in the drawing:

FIG. 1 shows, in each case, an exemplary time profile of a sensor signal of a functional coolant temperature sensor and a functional cylinder head temperature sensor, or respectively ordered time profiles of a coolant temperature and a cylinder head temperature for an engine cooling system during and after cold-starting of an internal combustion engine of a motor vehicle without an additional heating system being operated beforehand; and

FIG. 2 shows, in each case, a time profile of the sensor signals or the temperatures analogously to FIG. 1, but with an additional heating system of the motor vehicle, which heating system is independent of the internal combustion engine, being operated beforehand.

### DETAILED DESCRIPTION

According to various embodiments, an improved method for monitoring a coolant temperature sensor and/or a cylinder head temperature sensor in a motor vehicle, and also a control device for said method can be specified. In this process, it should be possible in particular to take into consideration preheating of an engine block and/or of a passenger compartment. This should also be possible, in particular, in the case of switchable coolant pumps and/or in the case of an additional heating system which has been retrofitted in the vehicle. In the process, it should be possible to implement the method according to various embodiments in as cost-effective a manner as possible and, in particular, to manage without additional components on/in the motor vehicle.

In the method according to various embodiments, a coolant temperature is ascertained by a coolant temperature sensor and a cylinder head temperature is ascertained by a cylinder head temperature sensor shortly before, while or shortly after, that is to say when, an internal combustion engine of the motor vehicle is started. Both the coolant temperature sensor and the cylinder head temperature sensor are diagnosed as a functional sensor when both the coolant temperature and the cylinder head temperature deviate in the same direction upward in relation to an outside temperature and/or an intake air temperature. It is also possible to in each case diagnose just one of the sensors as a functional sensor.

This means that the internal combustion engine or the motor vehicle has been heated or preheated by means of an additional heating system. This applies particularly to stationary heating systems and/or block heaters; it goes without saying that other additional heating systems can also be detected in this way.

One advantage of the method according to various embodiments is that preheating of the motor vehicle, preferably preheating of an interior and/or of the internal combustion engine or an engine block, can be detected without any information from an engine control system. In this case, the method according to various embodiments can also be applied to internal combustion engines with switchable coolant pumps. This is advantageous for retrofitted additional heating systems in motor vehicles since the engine control system is usually not aware of said additional heating systems. This also means that a retrofitted additional heating system of this kind can be identified, that is to say at least the presence of an additional heating system and possibly the operation of said additional heating system can be identified, by the engine control system.

According to various embodiments, undesired incorrect entries in relation to the coolant and/or the cylinder head temperature sensor are not made in a control device, and therefore there is no need to visit a garage and there are no unnecessary costs for replacing the sensor in question in this respect. The motor vehicle is compliant with OBD (ON-Board Diagnosis) in this respect. Furthermore, no starting or emission problems arise in the internal combustion engine even at low outside temperatures since, according to various embodiments, it is not concluded that the temperature sensor is a hanging temperature sensor, but rather said temperature sensor displays a correct temperature in each case. The method according to various embodiments is simple to use since information is merely combined in a new way in order to arrive at the result according to various embodiments. No additional structural outlay is required in the method according to various embodiments, that is to say the method can be implemented in a cost-effective manner since it manages without additional components in the motor vehicle and, can be implemented, for example, in a control device, for example an ECU (Engine Control Unit), for the internal combustion engine.

In embodiments, a decision can be made as to whether the coolant temperature is unexpectedly high and/or the cylinder head temperature is unexpectedly high, shortly before, while or shortly after, that is to say when, the internal combustion engine is started. The further method is then carried out only after this in such a case. This means that a profile, which follows this in respect of time, of the temperatures is examined for deviation in the same direction upward in relation to the outside temperature and/or the intake air temperature.

For the purpose of detecting the unexpectedly high coolant and/or cylinder head temperature, the respective temperature can be compared with the outside temperature, for example ascertained by an ambient temperature sensor, with the intake air temperature, for example ascertained by an intake air temperature sensor, or with another item of temperature information, for example one which is provided externally in a wireless manner, when the internal combustion engine is started. It is also possible to calculate this temperature information from other known values. When there is a specific deviation, an unexpectedly high coolant temperature is output and the procedure described above is followed.

A preferred criterion for detecting starting of the internal combustion engine which has been preheated by an additional heating system, that is to say a criterion for a functional, non-hanging coolant or cylinder head temperature sensor, is, for example, a specific deviation in the coolant temperature and/or the cylinder head temperature from the outside temperature and/or the intake air temperature. A further criterion is, for example, a specific deviation in the coolant temperature from the cylinder head temperature if both temperatures deviate upward from the outside temperature and/or the intake air temperature.

A gradient of the comparatively high coolant or cylinder head temperature or examination of a dynamic behavior of the cylinder head temperature in relation to the coolant temperature after the internal combustion engine is started is also suitable. A comparative value which is ascertained for this purpose in each case can be a current, average, minimum and/or maximum value. A defective coolant temperature sensor or a defective cylinder head temperature sensor can be diagnosed, for example, when either the coolant temperature or the cylinder head temperature does not increase after the internal combustion engine is started but the respectively other value does.

The method according to various embodiments can be preferably carried out as the profile of the coolant temperature and/or the cylinder head temperature being monitored. In this case, the profile is preferably monitored with a narrow time frame, for example a 50 ms, 75 ms, 100 ms, 125 ms, 150 ms, 200 ms or 250 ms frame, preferably at least until a specific respective temperature is reached and/or for a specific respective time period.

A time window can be provided between the first measurement of the coolant temperature and/or the cylinder head temperature for the purpose of starting the internal combustion engine, and beginning the increase in the relevant temperature. This means that the relevant temperature does not substantially change within this time period. A respective increase can be observed only afterward. A duration of the time window for an initial increase in the coolant temperature and/or the cylinder head temperature can be 0.05 s to 2 s, particularly 0.15 s to 1.5 s and preferably 0.25 s to 1.25 s.

According to various embodiments, it is also possible to use, instead of a first measurement or a first value/measured value of the coolant temperature and/or the cylinder head temperature, a later one. This means that the respectively first measured value or the respectively initial measured values are ignored and the method is started only then. Therefore, for example, the respectively “first” measured value for the method can be that which assumes a respectively first relatively high measured value, with a relatively high measured value being a measured value which deviates downward from the previous measured value by a specific amount. This amount is preferably predefined and is an empirical or simulated value. This is preferably subject to a time limit.

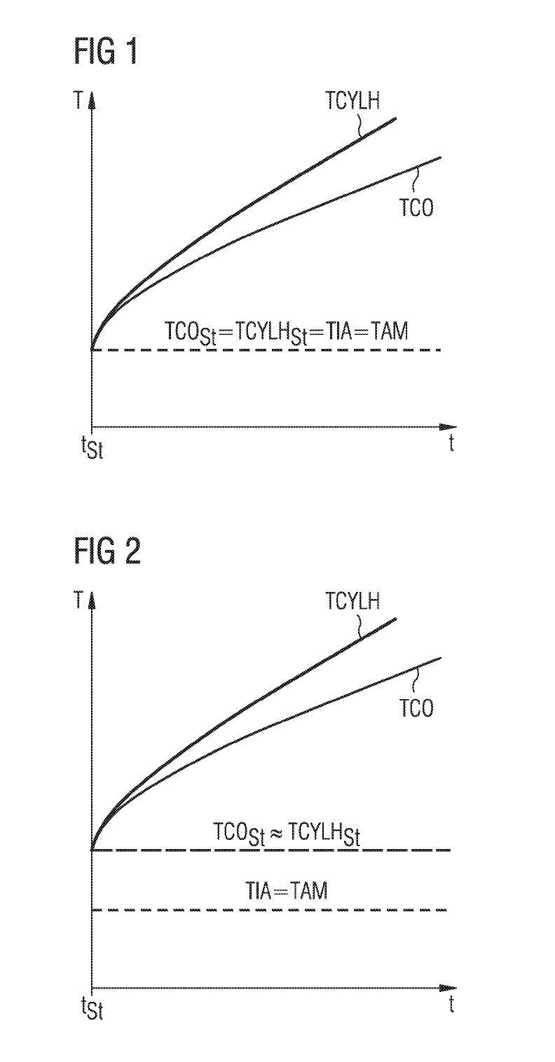

When cold-starting an internal combustion engine which has been off for long enough that a temperature of the internal combustion engine is equal to an outside temperature TAM, a coolant temperature TCO of a cooling system of the internal combustion engine is equal to the outside temperature TAM and therefore also to an intake air temperature TIA of the internal combustion engine: TCO=TAM=TIA. See the horizontal dashed line in FIG. 1. When the internal combustion engine is started t=t_{St}, a defective, high-hanging coolant temperature sensor would be identified and displayed since, in such a case, a sensor value TCO represents a coolant temperature TCO which is greater than the outside temperature TAM or the intake air temperature TIA of the internal combustion engine: TCO>TAM=TIA.

However, additional heating systems are used in motor vehicles when outside temperatures TAM are low. An additional heating system of this kind is a heating system which is independent of the internal combustion engine and can be an internal or an external additional electrical or combustion heating system. Therefore, the additional heating system is, for example, a preheating system, a stationary heating system, a block heater, an auxiliary fuel heater, an additional air or coolant heating system, an additional PTC heating system, a glow plug and/or another heating device. If an additional heating system of this kind was active before the internal combustion engine was started after a long downtime, a similar temperature equation to that above is produced: TCO>TAM=TIA. This means that although the coolant temperature sensor functions without faults, it will be identified as being faulty by a diagnosis which compares temperatures, and accordingly entered as such in a fault memory of an engine control system and unnecessarily replaced at the next visit to a garage.

Since an additional heating system does not heat up all the coolant uniformly, a brief drop in the coolant temperature TCO can be expected after the internal combustion engine is started (not illustrated in the drawing). However, internal combustion engines which also have a cylinder head temperature sensor in addition to the coolant temperature sensor are now being used, but with an internal combustion engine of this kind being equipped with an electrically or mechanically switchable coolant pump which prevents circulation of the coolant particularly when the internal combustion engine is started t=t_{St}. The relationship between the internal combustion engine being started t=t_{St} and the coolant temperature TCO dropping can no longer be observed here and can no longer be used for diagnosis of the coolant temperature sensor when an internal combustion engine of this kind is started t=t_{St}. A method of this kind is not suitable when starting the coolant pump either since this behavior is not pronounced or is only slightly pronounced.

However, on account of the cylinder head temperature sensor, a cross-plausibility check can be expanded by this additional information. When an internal combustion engine which was off for long enough is cold-started t=t_{St}, a temperature of the internal combustion engine or a cylinder head temperature TCYLH will equal the outside temperature TAM. Therefore, TCYLH=TAM=TIA=TCO. See the horizontal dashed line in FIG. 1. When this internal combustion engine is started t=t_{St}, a defective, high-hanging cylinder head temperature sensor would be identified and displayed since, in a case such as this, a sensor value TCYLH represents a cylinder head temperature TCYLH which is greater than the outside temperature TAM or the intake air temperature TIA of the internal combustion engine: TCYLH>TAM=TIA=TCO. The same applies for a high-hanging coolant temperature sensor: TCO>TAM=TIA=TCYLH (see above).

FIG. 1 shows starting of an internal combustion engine without an additional heating system being operated beforehand. Starting from time t_{St} of the starting of the internal combustion engine, the coolant temperature TCO and the cylinder head temperature TCYLH increase continuously in the first minutes, with the cylinder head temperature TCYLH having higher dynamics. FIG. 2 shows a similar case, but with an additional heating system being operated beforehand. When the internal combustion engine is started t=t_{St} in this way after a long downtime of the motor vehicle, the measured coolant temperature TCO and the measured cylinder head temperature TCYLH is higher than the outside temperature TAM and the intake air temperature TIA: TCO>TAM=TIA and TCYLH>TAM=TIA. In this case, the two temperatures TCO, TCYLH can deviate from one another (not illustrated in the drawing) or have a similar value. However, both temperatures TCO, TCYLH are above a level of the outside temperature TAM or the intake air temperature TIA. Also see, in FIG. 2, the profile of the curve of the coolant temperature TCO and the cylinder head temperature TCYLH after the internal combustion engine is started t>t_{St}, with both temperatures TCO, TCYLH initially being steep and then increasing moderately.

Therefore, if the measured coolant temperature TCO and the measured cylinder head temperature TCYLH are both together clearly above a level of the outside temperature TAM or the intake air temperature TIA, it is concluded according to various embodiments that the sensors are functional in each case. If one of the two temperatures TCO, TCYLH is significantly above the outside temperature TAM or the intake air temperature TIA but the other of the two temperatures TCYLH, TCO is not, a correspondingly defective, that is to say high-hanging, sensor can be detected. If one of the two sensors is actually hanging and it is preheated, a defective sensor cannot be detected, this not being a problem for starting the internal combustion engine since, despite this, starting with preheating is detected. The defective sensor can be identified in a subsequent diagnosis. The situation of both sensors hanging at the same time is too improbable to take into consideration.

The method according to various embodiments can be preferably carried out only after a comparatively long downtime, with the downtime preferably lasting at least approximately 4 h to 8 h. Furthermore, the method is preferably carried out only at low outside temperatures TAM. In this case, the outside temperatures TAM are preferably below 10° C., in particular below 0° C.

What is claimed is:

1. A method for monitoring at least one of a coolant temperature sensor and a cylinder head temperature sensor of a motor vehicle, the method comprising:
when an internal combustion engine of the motor vehicle is started, determining an actual value of a coolant temperature by a coolant temperature sensor, and determining an actual value of a cylinder head temperature by a cylinder head temperature sensor, wherein
at least one of the coolant temperature sensor and the cylinder head temperature sensor is diagnosed as a functional sensor when the actual values of the coolant temperature and of the cylinder head temperature deviate in the same direction upward in relation to at least one of an outside temperature and an intake air temperature.

2. The method according to claim 1, wherein, for the purpose of starting the internal combustion engine, a decision is initially made as to whether at least one of the coolant temperature and the cylinder head temperature have an unexpectedly high actual value, and
the deviation in the same direction of the actual values of the coolant temperature and of the cylinder head temperature upward is examined only in such a case.

3. The method according to claim 1, wherein, for the purpose of starting the internal combustion engine, the actual value of at least one of the coolant temperature and the actual value of the cylinder head temperature are compared with at least one of the outside temperature and the intake air temperature, and in the case of a specific deviation in one or both temperatures, at least one of an unexpectedly high actual value for the coolant temperature and an unexpectedly high actual value for the cylinder head temperature is output, and the method is carried out after this.

4. The method according to claim 1, wherein at least one of a functional coolant temperature sensor and a functional cylinder head temperature sensor is diagnosed, or the internal combustion engine is started with previous additional heating of the motor vehicle, by:
a predetermined deviation of at least one of the coolant temperature and the cylinder head temperature from at least one of the external temperature and the intake air temperature;
a predetermined deviation in the coolant temperature from the cylinder head temperature if the two temperatures deviate upward from at least one of the outside temperature and the intake air temperature;
a predetermined positive gradient of at least one of the coolant temperature and the cylinder head temperature after the internal combustion engine is started,
examination of a dynamic behavior of the cylinder head temperature in relation to the coolant temperature after the internal combustion engine is started.

5. The method according to claim 1, wherein a defective coolant temperature sensor or a defective cylinder head temperature sensor is diagnosed when either the actual value of the coolant temperature or the actual value of the cylinder head temperature does not increase after the internal combustion engine is started.

6. The method according to claim 1, wherein the profile of at least one of the coolant temperature and the cylinder head temperature is monitored after the internal combustion engine is started, wherein
the profile is monitored with a narrow time frame and is continued until a specific respective temperature is at least one of reached and lasts for a specific respective time period.

7. The method according to claim 1, wherein a duration of a time window for an initial increase in at least one of the actual value of the coolant temperature and the actual value of the cylinder head temperature is 1 s after the internal combustion engine is started.

8. The method according to claim 1, wherein at least one of:
the method is carried out only after a comparatively long downtime of the internal combustion engine, and the downtime is at least 4 h, and
the method is carried out only in the case of a low outside temperature which is ascertained by an ambient temperature sensor, an intake air temperature sensor or in some other way, and the outside temperature ascertained in the process is below 10° C.

9. The method according to claim 1, wherein the additional heating system is a heating system which is independent of the internal combustion engine and comprises an internal or an external additional electrical or combustion heating system.

10. A control device or an engine control device for a motor vehicle, wherein the control device is configured when an internal combustion engine of the motor vehicle is started, to determine an actual value of a coolant temperature by a coolant temperature sensor, and to determine an actual value of a cylinder head temperature by a cylinder head temperature sensor, and to diagnose at least one of the coolant temperature sensor and the cylinder head temperature sensor as a functional sensor when the actual values of the coolant temperature and of the cylinder head temperature deviate in the same direction upward in relation to at least one of an outside temperature and an intake air temperature.

11. The control device according to claim 10, wherein, for the purpose of starting the internal combustion engine, the device is configured to initially decide as to whether at least one of the coolant temperature and the cylinder head temperature have an unexpectedly high actual value, and
the deviation in the same direction of the actual values of the coolant temperature and of the cylinder head temperature upward is examined only in such a case.

12. The control device according to claim 10, wherein, the control device is further configured, for the purpose of starting the internal combustion engine, to compare the actual value of at least one of the coolant temperature and the actual value of the cylinder head temperature with at least one of the outside temperature and the intake air temperature, and in the case of a specific deviation in one or both temperatures, to output at least one of an unexpectedly high actual value for the coolant temperature and an unexpectedly high actual value for the cylinder head temperature, and to carry out the method out after this.

13. The control device according to claim 10, wherein at least one of a functional coolant temperature sensor and a functional cylinder head temperature sensor is diagnosed, or the internal combustion engine is started with previous additional heating of the motor vehicle, by:
a predetermined deviation of at least one of the coolant temperature and the cylinder head temperature from at least one of the external temperature and the intake air temperature;
a predetermined deviation in the coolant temperature from the cylinder head temperature if the two temperatures deviate upward from at least one of the outside temperature and the intake air temperature;
a predetermined positive gradient of at least one of the coolant temperature and the cylinder head temperature after the internal combustion engine is started,
examination of a dynamic behavior of the cylinder head temperature in relation to the coolant temperature after the internal combustion engine is started.

14. The control device according to claim 10, wherein a defective coolant temperature sensor or a defective cylinder head temperature sensor is diagnosed when either the actual value of the coolant temperature or the actual value of the cylinder head temperature does not increase after the internal combustion engine is started.

15. The control device according to claim 10, wherein the profile of at least one of the coolant temperature and the cylinder head temperature is monitored after the internal combustion engine is started, wherein
the profile is monitored with a narrow time frame and is continued until a specific respective temperature is at least one of reached and lasts for a specific respective time period.

16. The method according to claim 4, wherein a comparative value which is ascertained for this purpose in each case is at least one of a current, average, minimum and maximum value.

17. The method according to claim 7, wherein the duration of the time window is 0.75 s, 0.4 s, 0.2 s or 0.1 s, after the internal combustion engine is started.

18. The method according to claim 8, wherein the downtime is at least 8 h, at least 7 h, at least 6 h or at least 5 h.

19. The method according to claim 8, wherein the low outside temperature is below 5° C., below 0° C., below −5° C., or below −10° C.

20. The method according to claim 9, wherein the additional heating system is at least one of a preheating system, a stationary heating system, a block heater, an auxiliary fuel heater, an additional air or coolant heating system, an additional PTC heating system, a glow plug and another heating device.
